(19) United States
(12) Patent Application Publication
(10) Pub. No.: US 2025/0100470 A1
(43) Pub. Date: Mar. 27, 2025

(54) COMPOSITE CABLE AND COMPOSITE HARNESS

(71) Applicant: Proterial, Ltd., Tokyo (JP)

(72) Inventors: Hirotaka ESHIMA, Tokyo (JP); Yoshikazu HAYAKAWA, Tokyo (JP); Takahiro FUTATSUMORI, Tokyo (JP)

(21) Appl. No.: 18/813,617

(22) Filed: Aug. 23, 2024

(30) Foreign Application Priority Data
Sep. 21, 2023 (JP) 2023-155562

(51) Int. Cl. B60R 16/02; B60T 8/17; B60T 8/32; H01B 7/00; H01B 9/00; H01B 11/04

(52) U.S. Cl. CPC B60R 16/0215; H01B 7/0045; H01B 9/003; H01B 11/04; B60T 8/17; B60T 8/329

(57) ABSTRACT

A composite cable includes a plurality of power lines for supplying an operating power source to a device to be controlled; a plurality of first signal lines for transmitting control signals for controlling the device to be controlled; a plurality of second signal lines for transmitting detection signals of a sensor for detecting a physical quantity; and a sheath collectively covering the plurality of power supply lines, the plurality of first signal lines, and the plurality of second signal lines, wherein a signal line section in which the plurality of first signal lines and the plurality of second signal lines are twisted together and the plurality of power lines are twisted together inside the sheath, and the plurality of first signal lines and the plurality of second signal lines are twisted together in a spiral shape all together around a central axis of the signal line section.

### CROSS-REFERENCE TO RELATED APPLICATIONS

The present patent application claims the priority of Japanese patent application No. 2023-155562 filed on Sep. 21, 2023, and the entire contents thereof are hereby incorporated by reference.

### TECHNICAL FIELD

This disclosure relates to a composite cable having a plurality of power lines and a plurality of signal lines, and to a composite harness with a connector at the end of the composite cable.

### BACKGROUND OF THE INVENTION

Conventionally, composite cables having multiple power lines and multiple signal lines are used to connect devices. The composite cable described in Patent Literature 1 is for electric brakes of automobiles, and one end is fixed to a vehicle body or undercarriage, while the other end is attached to the wheel peripheral parts that vibrate up and down. This composite cable has a pair of power lines, a signal line section consisting of twisted first and second signal lines, and a sheath covering the pair of power lines and the signal lines. The first and second signal lines are twisted pair wires, each consisting of a twisted pair of wires each of which includes a conductor covered with an insulator.

### CITATION LIST

Patent Literature 1: JP2022-123143A

### SUMMARY OF THE INVENTION

When one of the devices connected by a composite cable is a moving part, high bending endurance and disconnection resistance are required. To improve bending endurance and disconnection resistance, it is effective to reduce the outer diameter of the cable. However, the outer diameter of the signal line section of the cable described in Patent Literature 1 is large because the signal line section is formed by twisting the twisted pair wires. Therefore, the object of the present invention is to provide a composite cable that can be made smaller in diameter, and a composite harness equipped with the composite cable and a connector.

So as to solve the above problem, one aspect of the present invention provides a composite cable, comprising: a plurality of power lines for supplying an operating power source to a device to be controlled; a plurality of first signal lines for transmitting control signals for controlling the device to be controlled; a plurality of second signal lines for transmitting detection signals of a sensor for detecting a physical quantity; and a sheath collectively covering the plurality of power supply lines, the plurality of first signal lines, and the plurality of second signal lines, wherein a signal line section in which the plurality of first signal lines and the plurality of second signal lines are twisted together and the plurality of power lines are twisted together inside the sheath, and the plurality of first signal lines and the plurality of second signal lines are twisted together in a spiral shape all together around a central axis of the signal line section.

Further, so as to solve the above problem, another aspect of the present invention provides a composite harness, comprising: the composite cable according to claim 1; and a connector at an end of the composite cable.

### Effects of the Invention

According to the present invention, it is possible to provide a composite cable that can be made smaller in diameter, and a composite harness equipped with the composite cable and a connector.

### BRIEF DESCRIPTION OF DRAWINGS

FIG. 1 is a schematic diagram illustrating a configuration example of a vehicle having a composite cable and a composite harness according to the first embodiment.

FIG. 2 is an explanatory diagram illustrating a configuration example of an electric brake unit together with parts of a composite cable and a composite harness.

FIG. 3 is a cross-sectional view of the composite cable.

FIG. 4 is a cross-sectional view illustrating a configuration of a composite cable shown as a comparative example.

FIG. 5 is an explanatory diagram illustrating a configuration of a composite cable and a composite harness according to the second embodiment.

### DETAILED DESCRIPTION OF THE INVENTION

### First Embodiment

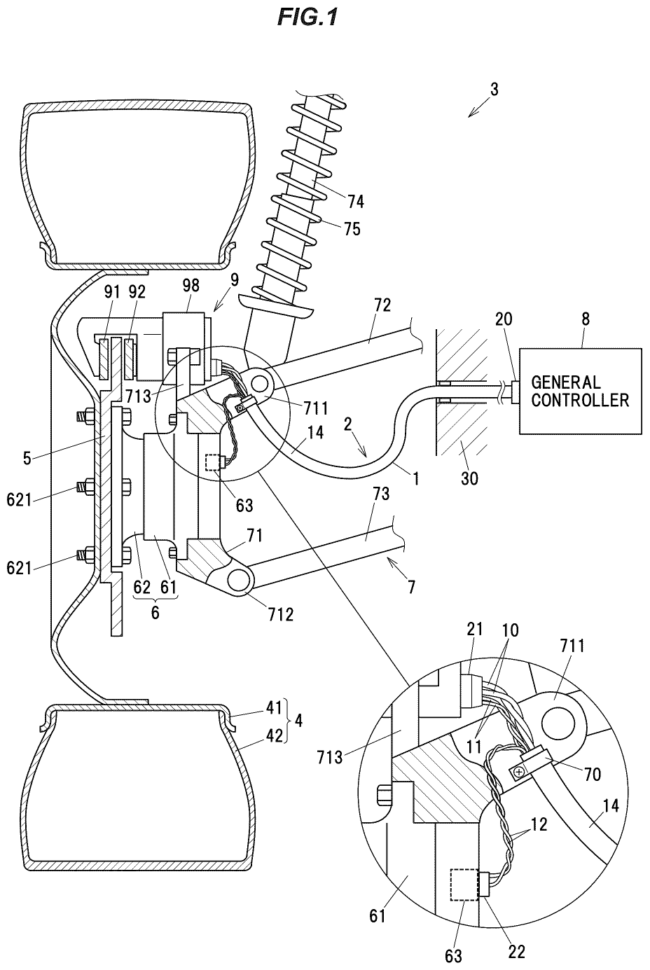

FIG. 1 is a schematic diagram illustrating a configuration example of a vehicle 3 having a composite cable 1 and a composite harness 2 according to the first embodiment. The vehicle 3 comprises a vehicle wheel 4 having a wheel 41 made of metal and a tire 42 made of rubber, a brake rotor 5 rotating together with the wheel 41, a hub unit 6 that rotatably supports the vehicle wheel 4 and the brake rotor 5, a suspension system 7 that supports the hub unit 6 against the vehicle body 30, a general controller 8 which is a control unit to comprehensively control the vehicle 3, and an electric brake unit 9, which brakes the vehicle wheel 4 under instructions from the general controller 8.

The suspension system 7 is composed of a knuckle 71, an upper arm 72, a lower arm 73, a damper 74, and a suspension spring 75. The upper arm 72 and the lower arm 73 are respectively connected to the knuckle 71 at one end and to the vehicle body 30 at the other end. The hub unit 6 has an outer wheel 61 attached to the knuckle 71, a hub wheel 62 rotatably supported with respect to the outer wheel 61, and a wheel speed sensor 63 that detects the rotation speed of the vehicle wheel 4. The knuckle 71 has a first connecting section 711 to which the upper arm 72 and the damper 74 are connected, a second connecting section 712 to which the lower arm 73 is connected, and a mounting section 713 to which the electric brake unit 9 is attached.

The wheel 41 and the brake rotor 5 are fixed to the hub wheel 62 of the hub unit 6 by a plurality of hub bolts 621. The wheel speed sensor 63 detects the rotation speed of the hub wheel 62 relative to the outer wheel 61 as the rotation speed of the vehicle wheel 4. Specifically, the wheel speed sensor 63 outputs a pulse signal with a pulse interval corresponding to the rotation speed of the hub wheel 62 with respect to the outer wheel 61 as a detection signal. The general controller 8 controls the electric brake unit 9 based on information such as the amount of depressing the brake pedal by the driver of the vehicle 3 and the rotation speed of the vehicle wheel 4 detected by the wheel speed sensor 63. The electric brake unit 9 is a control target device of the general controller 8, which is to be controlled by the general controller 8.

The electric brake unit 9, together with the vehicle wheels 4, the brake rotor 5, the hub unit 6, and the knuckle 71, moves vertically with respect to the vehicle body 30 as the suspension spring 75 extends and retracts. A part in the longitudinal direction of the composite cable 1 is wired in the air and connects the electric brake unit 9 to the general controller 8.

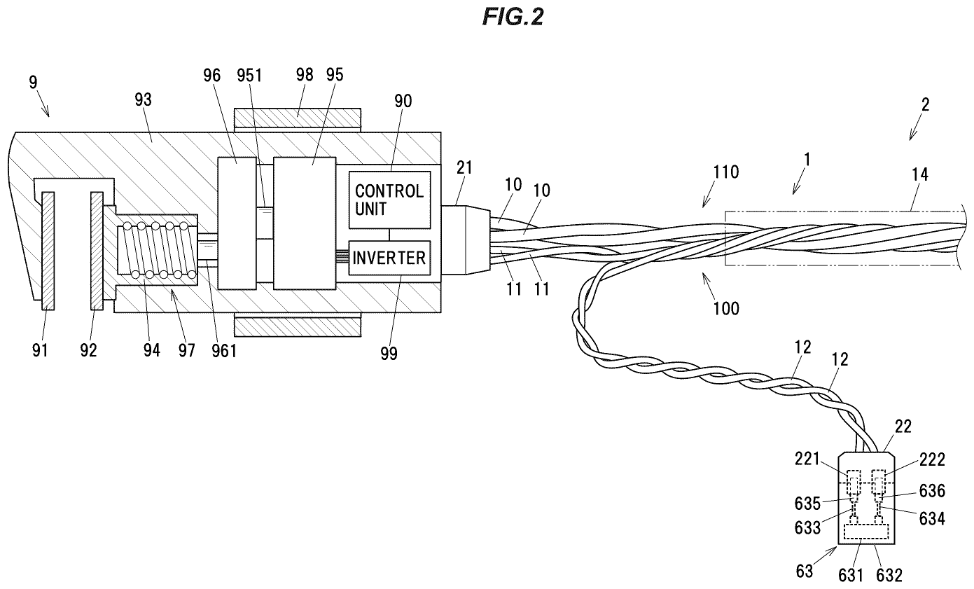

FIG. 2 is an explanatory diagram illustrating a configuration example of the electric brake unit 9 together with the composite cable 1 and the composite harness 2. The electric brake unit 9 comprises a control unit 90 that communicates with the general controller 8 via the composite cable 1, an outer brake pad 91 and an inner brake pad 92, a caliper 93 with the outer brake pad 91 attached, and a piston 94 with the inner brake pad 92 attached, a motor 95 which is the driving source of the electric brake unit 9, a reduction gear 96 which reduces the rotation of a motor shaft 951 which is an output shaft of the motor 95, and a rotation-linear motion converting mechanism 97 which converts the rotary motion of an output shaft 961 of the reduction gear 96 into linear motion of the piston 94, a caliper bracket 98 which is fixed to the mounting section 713 of the knuckle 71, and an inverter 99 which supplies current to the motor 95. The caliper 93 is supported by the caliper bracket 98 and can move parallel to the axis of rotation of the vehicle wheel 4 with respect to the caliper bracket 98.

The reduction gear 96 reduces the rotation of the motor shaft 951 and transmits the torque of the motor 95 to the rotation-linear motion converting mechanism 97. The rotation-linear motion converting mechanism 97 is composed of a ball screw mechanism, for example. When the motor 95 rotates by the current supplied from the inverter 99, the outer brake pad 91 and the inner brake pad 92 are pressed toward the brake rotor 5 by the pressing force corresponding to the torque generated by the motor 95, and the vehicle wheel 4 is braked by the frictional force generated between the outer brake pad 91 and the inner brake pad 92 and the brake rotor 5.

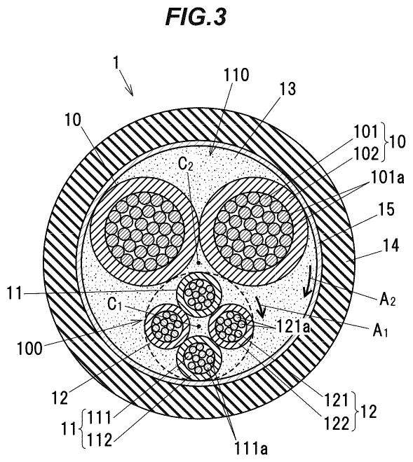

FIG. 3 is a cross-sectional view of the composite cable 1. The composite cable 1 has a plurality of power lines 10 for supplying operating power to the electric brake unit 9, a plurality of first signal lines 11 for transmitting control signals for controlling the electric brake unit 9, a plurality of second signal lines 12 for transmitting the detection signals from the wheel speed sensor 63, a fiber-like filler 13, and a hollow tubular sheath 14. The number of power lines 10, first signal lines 11, and second signal lines 12 included in the composite cable 1 are two each.

The two power lines 10 consist of one positive power line and one negative power line. These power lines 10 are insulated wires each of which includes a center conductor 101 covered with an insulator 102 made of insulating resin. The center conductor 101 is a stranded wire composed of a plurality of conductor strands 101a twisted together. The voltage supplied to the electric brake unit 9 by the two power lines 10 is, for example, DC 12 V. The control unit 90 of the electric brake unit 9 is equipped with an electric circuit that operates by means of a voltage transformed by a DC-DC converter from the voltage supplied to the electric brake unit 9 by the two power lines 10, and the inverter 99 switches the voltage supplied to the electric brake unit 9 by the two power lines 10 and outputs it to the motor 95.

The two first signal lines 11 are insulated wires each of which includes a center conductor 111 covered with an insulator 112 made of insulating resin. The center conductor 111 is a stranded wire composed of a plurality of conductor strands 111a twisted together. A command signal indicating the magnitude of the braking force to be generated by the electric brake unit 9 is transmitted from the general controller 8 via the two first signal lines 11 to the control unit 90 of the electric brake unit 9. The control unit 90 outputs a PWM signal to the inverter 99 to control the motor 95 in such a manner that the braking force corresponding to this command signal is generated.

The two second signal lines 12 are insulated wires each of which includes a center conductor 121 covered with an insulator 122 made of insulating resin. The center conductor 121 is a stranded wire consisting of a plurality of conductor strands 121a twisted together. The information on the rotational speed of the vehicle wheel 4 obtained from the detection signal of the wheel speed sensor 63 transmitted by these second signal lines 12 is used in the general controller 8 to control the electric brake unit 9, and is also used, for example, to control the power steering system and the engine or electric motor as the driving source of the vehicle 3.

The filler 13 is a fibrous material such as, for example, aramid or nylon fibers. The sheath 14 is made of a resin such as soft polyurethane with excellent flexibility and durability. The sheath 14 collectively covers the plurality of power lines 10, the plurality of first signal lines 11, the plurality of second signal lines 12, and the filler 13. In the vicinity of the electric brake unit 9, the sheath 14 is removed and the plurality of power lines 10, the plurality of first signal lines 11, and the plurality of second signal lines 12 are exposed from the sheath 14. In FIG. 2, the plurality of power lines 10, the plurality of first signal lines 11, and the plurality of second signal lines 12 inside the sheath 14 are illustrated, with the sheath 14 shown as two dotted lines.

The plurality of first signal lines 11 and the plurality of second signal lines 12 are twisted together to form the signal line section 100. The signal line section 100 and the plurality of power lines 10 are twisted together inside the sheath 14 to form a wire assembly 110. The plurality of first signal lines 11 and the plurality of second signal lines 12 are collectively twisted together in a helical manner around a central axis C₁ of the signal line section 100 shown in FIG. 3. The signal line section 100 and the plurality of power lines 10 are helically twisted together around a central axis C₂ of the composite cable 1. A tape member 15 made of resin such as PET (Poly Ethylene Terephthalate), for example, is wound around an outer circumference of the wire assembly 110. A shield layer made of a shield conductor such as a braided shield may be provided around an outer circumference of the signal line section 100.

In FIG. 3, the twist direction of the plurality of first signal lines 11 and plurality of second signal lines 12 and the twist direction of the signal line section 100 and the plurality of power lines 10 are indicated by arrows A₁, A₂, respectively. In the present embodiment, the twist direction of the plurality of first signal lines 11 and the plurality of second signal lines 12 and the twist direction of the signal line section 100 and the plurality of power lines 10 are the same. This allows the twists of the signal line section 100 and the wire assembly 110 to tighten and loosen together when the composite cable 1 is twisted to distribute the load and improve durability against twisting. However, not limited to this, the twist direction of the plurality of first signal lines 11 and plurality of second signal lines 12 and the twist direction of the signal line section 100 and the plurality of power lines 10 can be reversed. In this case, bending habits of the composite cable 1 caused by twisting can be suppressed.

The first signal line 11 and the second signal line 12 share the same outer diameter, material, and other various properties. In the present embodiment, the two first signal lines 11 and the two second signal lines 12 are arranged alternately in the circumferential direction of the signal line section 100 around the central axis C₁, with the two first signal lines 11 being positioned across the central axis C₁ and the two second signal lines 12 being positioned across the central axis C₁. This alternating arrangement of the two first signal lines 11 and the two second signal lines 12 makes the direction of the magnetic field generated by the current flowing in the two first signal lines 11 and the alignment direction of the two second signal lines 12 the same. Since the magnetic field generated by the current flowing in the two second signal lines 12 and the alignment direction of the two first signal lines 11 are the same, crosstalk (leakage) between the control signal and the detection signal of the wheel speed sensor 63 is suppressed.

However, not limited to this, the two first signal lines 11 may be arranged adjacent to each other in the circumferential direction of the signal line section 100, and the two second signal lines 12 may be arranged adjacent to each other in the circumferential direction of the signal line section 100. In this case, the two first signal lines 11 and the two second signal lines 12 are easier to separate in the terminal processing work of the composite cable 1, which improves workability. The two first signal lines 11 and the two second signal lines 12 have different colors of insulators 112 and 122, respectively, and the terminal processing is performed based on these colors.

The composite harness 2 has connectors at a vehicle wheel 4-side end and a general controller 8-side end in the composite cable 1, respectively. In the present embodiment, the signal line section 100 splits outside the sheath 14 into the two first signal lines 11 and the two second signal lines 12, a first connector 21 is provided at the terminals of the two power lines 10 and the two first signal lines 11, and a second connector 22 is provided at the terminals of the two second signal lines 12. The first connector 21 is attached to the electric brake unit 9 and the second connector 22 is attached to the wheel speed sensor 63. At the end of the composite cable 1 on the side of the general controller 8, there is a connector 20 that is attached to the general controller 8, as shown in FIG. 1.

The end of the sheath 14 on the vehicle wheel 4-side is fixed to the first connecting section 711 of the knuckle 71 by a fixture 70 in the vicinity of the electric brake unit 9, as shown in FIG. 1. With the sheath 14 secured near the electric brake unit 9, the length of the portion of the plurality of power lines 10 and first signal lines 11 exposed from the sheath 14 is shorter than the length of the portion of the plurality of second signal lines 12 exposed from the sheath 14. The plurality of power lines 10 and the first signal lines 11 extend from the end of the sheath 14 toward the electric brake unit 9, and the plurality of second signal lines 12 extend from the end of the sheath 14 toward the wheel speed sensor 63. The twisting of the plurality of first signal lines 11 and the plurality of second signal lines 12 in the signal line section 100 is untwisted in the vicinity of the end of the sheath 14 outside the sheath 14.

The plurality of power lines 10, the first signal lines 11, and the second signal lines 12 exposed from the sheath 14 may be covered by a tubular protective material. A portion of the first connector 21 may be covered by a mold resin along with a portion of each of the plurality of power lines 10 and the first signal lines 11.

As shown in FIG. 2, the wheel speed sensor 63 has a magnetic field detection element 631, a molded body 632 that encapsulates the magnetic field detection element 631, and a plurality of electrode terminals 635, 636 connected to the terminals of the magnetic field detection element 631 by wires 633, 634. The second connector 22 has connection terminals 221, 222 that are connected to electrode terminals 635, 636 of the wheel speed sensor 63, respectively. The connection terminals 221, 222 are connected to the center conductors 121 of the two second signal lines 12, respectively.

### COMPARATIVE EXAMPLE

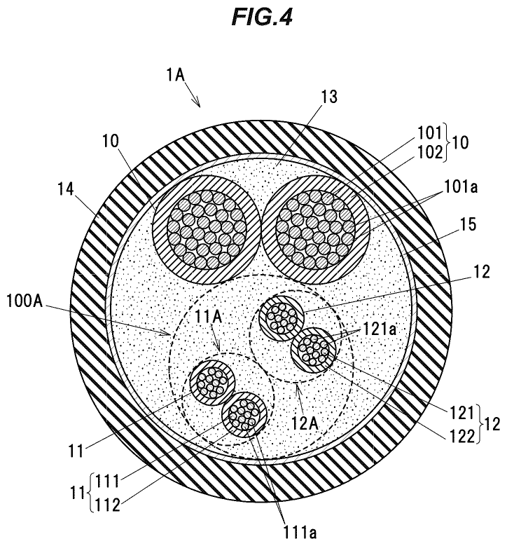

FIG. 4 is a cross-sectional view illustrating a configuration of a composite cable 1A shown as a comparative example. As the composite cable 1 according to the first embodiment, the composite cable 1A according to the comparative example has two power lines 10, first signal lines 11, and second signal lines 12, but the configuration of the twisting of the plurality of first signal lines 11 and second signal lines 12 is different. In the composite cable 1A according to the comparative example, a signal line section 100A is composed of a first twisted pair wire 11A consisting of the two first signal lines 11 twisted together and a second twisted pair wire 12A consisting of the two second signal lines 12 twisted together.

In the composite cable 1A, the maximum outer diameter of signal line section 100A is the combined dimensions of the respective outer diameters of the two first signal lines 11 and the respective outer diameters of the two second signal lines 12, which is larger than the outer diameter of the signal line section 100 of the composite cable 1 according to the first embodiment. This also makes the outer diameter of the composite cable 1A larger than that of the composite cable 1 according to the first embodiment.

### (Effects of the First Embodiment)

According to the first embodiment described above, the configuration in which the plurality of first signal lines 11 and the plurality of second signal lines 12 are twisted together in a spiral shape at once allows the outer diameter of the signal line section 100 and the outer diameter of the composite cable 1 to be reduced, and the composite cable 1 can be arranged more easily, and high bending durability and disconnection resistance. Further, in the first embodiment, the plurality of first signal lines 11 and the second signal lines 12 are arranged alternately in the circumferential direction centered on the central axis C₁, so that crosstalk between the control signal transmitted by the first signal line 11 and the detection signal of the wheel speed sensor 63 is suppressed.

In the first embodiment described above, the detection signal of the wheel speed sensor 63 is transmitted by the second signal line 12. However, the detection signal of a sensor other than the wheel speed sensor 63 may be transmitted by the second signal line 12. Such sensors include, for example, a current sensor that detects the current supplied to the motor 95 of the electric brake unit 9, a temperature sensor that detects the temperature of the motor 95, or a load sensor that detects the pressing force of the piston 94. In this case, the current supplied to the motor 95, the temperature of the motor 95, and the pushing force of the piston 94 are physical quantities detected by each sensor, and the general controller 8 can use the detection signals of these sensors for the electric brake unit 9. For example, the detection signals of the air pressure sensor that detects the air pressure of the tire 42 of the vehicle wheel 4 and the damper sensor that detects the amount of actuation of the damper 74 may be sent to the general controller 8 via the electric brake unit 9 and the plurality of second signal lines 12.

### Second Embodiment

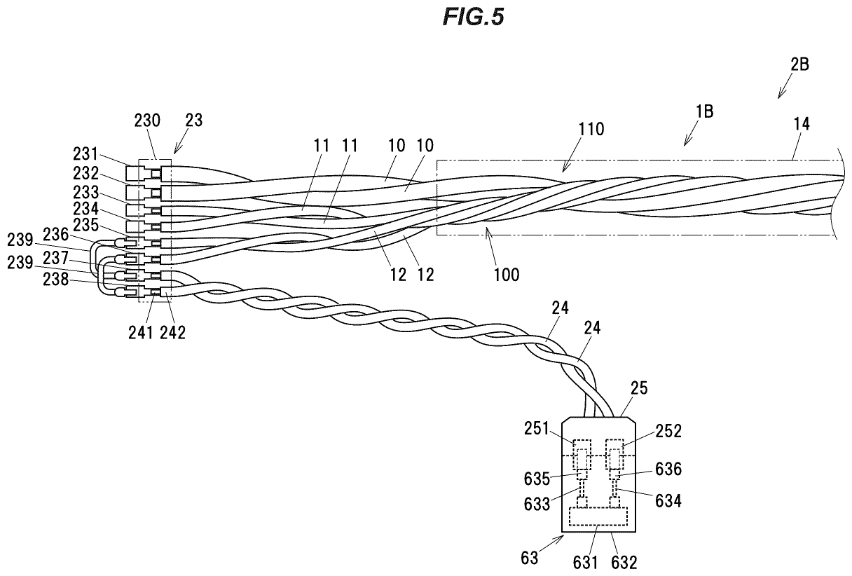

Next, a second embodiment of the present invention is described with reference to FIG. 5. FIG. 5 is an explanatory diagram illustrating a configuration of a composite cable 1B and a composite harness 2B according to the second embodiment.

In the first embodiment, the plurality of second signal lines 12 of the composite cable 1B are split (branched) from the plurality of first signal lines 11 and connected to the wheel speed sensor 63. In the present embodiment, at the vehicle wheel 4-side end in the composite cable 1B, the plurality of power lines 10, the plurality of first signal lines 11, and the one connector 23 attached to the electric brake unit 9 is provided at the terminal of the plurality of second signal lines 12.

The composite harness 2B also has a plurality of sensor signal lines 24 extending from the connector 23 and connected to the wheel speed sensor 63. The plurality of sensor signal lines 24 are insulated wires, each of which includes a center conductor 241 covered with an insulator 242 made of insulating resin. The terminals of the plurality of sensor signal lines 24 are provided with a sensor connector 25 having connection terminals 251 and 252 that are connected to electrode terminals 635 and 636 of the wheel speed sensor 63, respectively, similar to the second connector 22 described in the first embodiment.

The connector 23 has a connector housing 230 made of insulating resin and first to eighth terminals 231 to 238. The plurality of power lines 10, the plurality of first signal lines 11, the plurality of second signal lines 12, and the plurality of sensor signal lines 24 are connected to the first to eighth terminals 231 to 238, respectively. The first to fourth terminals 231 to 234 are connected to the terminals of a mating connector of the electric brake unit 9.

The fifth and seventh terminals 235 and 237, and the sixth and eighth terminals 236 and 238, respectively, are electrically shorted by short-circuit members 239. As a result, the detection signal of the wheel speed sensor 63 is sent from the plurality of sensor signal lines 24 through the plurality of second signal lines 12 to the general controller 8. The center conductor 241 of each of the plurality of sensor signal lines 24 and the center conductor 121 of each of the plurality of second signal lines 12 may be directly connected by solder, for example. The connection destination of the sensor connector 25 is not limited to the wheel speed sensor 63, but may also be a sensor that detects other physical quantities, such as an air pressure sensor or damper sensor, for example.

This second embodiment also provides the same effects as the first embodiment. Since the plurality of first signal lines 11 and the plurality of second signal lines 12 are not spit (branched), the plurality of power lines 10, the plurality of first signal lines 11, and the plurality of second signal lines 12 can be covered by the sheath 14 up to the vicinity of the connector 23. It is possible to prevent the plurality of power lines 10, the plurality of first signal lines 11, and the plurality of second signal lines 12 from being damaged by chipping (flying rocks), etc. To prevent the plurality of sensor signal lines 24 from being damaged by chipping (flying rocks), etc., the plurality of sensor signal lines 24 may be covered by a tubular protective material. A sheath covering the plurality of sensor signal lines 24 may also be provided.

### SUMMARY OF THE EMBODIMENTS

Next, technical ideas understood from the first and second embodiments explained above will be described with reference to the reference numerals and the like used in the embodiments. However, each reference numeral in the following description does not limit the constituent elements in the scope of claims to the members and the like specifically shown in the embodiments.

[1] A composite cable (1, 1B) includes a plurality of power lines (10) for supplying an operating power source to a device to be controlled (an electric brake unit 9); a plurality of first signal lines (11) for transmitting control signals for controlling the device to be controlled (9); a plurality of second signal lines (12) for transmitting detection signals of a sensor (wheel speed sensor 63) for detecting a physical quantity; and a sheath (14) collectively covering the plurality of power supply lines (10), the plurality of first signal lines (11), and the plurality of second signal lines (12), wherein a signal line section (100) in which the plurality of first signal lines (11) and the plurality of second signal lines (12) are twisted together and the plurality of power lines (10) are twisted together inside the sheath (14), and the plurality of first signal lines (11) and the plurality of second signal lines (12) are twisted together in a spiral shape all together around a central axis (C₁) of the signal line section (100).

[2] In the composite cable (1, 1B) according to [1], the plurality of first signal lines (11) and the plurality of second signal lines (12) are arranged alternately in the circumferential direction around the central axis (C₁).

[3] In the composite cable (1, 1B) according to [1], the signal line section (100) comprises two first signal lines (11) and two second signal lines (12) twisted together around the central axis (C₁), wherein the two first signal lines (11) are positioned across the central axis (C₁) and the two second signal lines (12) are positioned across the central axis (C₁).

[4] In the composite cable (1, 1B) according to [1], the device to be controlled (9) is an electric brake unit that brakes the vehicle wheel (4).

[5] In the composite cable (1, 1B) according to [4], wherein the sensor (63) is a wheel speed sensor that detects a rotational speed of the vehicle wheel (4).

[6] A composite harness (2, 2B) includes the composite cable (1, 1B) according to any one of [1] to [5], and a connector at an end of the composite cable (1, 1B).

[7] In the composite harness (2) according to [6], the signal line section (100) is split outside the sheath (14) into the plurality of first signal lines (11) and the plurality of second signal lines (12), wherein a first connector (21) is provided at terminals of the plurality of power lines (10) and the plurality of first signal lines (11), and a second connector (22) is provided at terminals of the plurality of second signal lines (12).

[8] In the composite harness (2B) according to [6], one connector (23) is provided at terminals of the plurality of power lines (10), the plurality of first signal lines (11), and the plurality of second signal lines (12), and a plurality of sensor signal lines (24) are provided to extend from the one connector (23) and are connected to the sensor (63), and the plurality of second signal lines (12) and the plurality of sensor signal lines (24) are electrically short-circuited.

The first and second embodiments of the present invention have been described above, but these embodiments do not limit the invention according to the scope of claims. Additionally, it should be noted that not all of the combinations of features described in the embodiments are essential to the means for solving problems of the invention.

1. A composite cable, comprising:
a plurality of power lines for supplying an operating power source to a device to be controlled;
a plurality of first signal lines for transmitting control signals for controlling the device to be controlled;
a plurality of second signal lines for transmitting detection signals of a sensor for detecting a physical quantity; and
a sheath collectively covering the plurality of power supply lines, the plurality of first signal lines, and the plurality of second signal lines,
wherein a signal line section in which the plurality of first signal lines and the plurality of second signal lines are twisted together and the plurality of power lines are twisted together inside the sheath, and the plurality of first signal lines and the plurality of second signal lines are twisted together in a spiral shape all together around a central axis of the signal line section.

2. The composite cable, according to claim 1, wherein the plurality of first signal lines and the plurality of second signal lines are arranged alternately in the circumferential direction around the central axis.

3. The composite cable, according to claim 1, wherein the signal line section comprises two first signal lines and two second signal lines twisted together around the central axis, wherein the two first signal lines are positioned across the central axis and the two second signal lines are positioned across the central axis.

4. The composite cable, according to claim 1, wherein the device to be controlled is an electric brake unit that brakes the vehicle wheel.

5. The composite cable, according to claim 4, wherein the sensor is a wheel speed sensor that detects a rotational speed of the vehicle wheel.

6. A composite harness, comprising:
the composite cable according to claim 1; and
a connector at an end of the composite cable.

7. The composite harness, according to claim 6, wherein the signal line section is split outside the sheath into the plurality of first signal lines and the plurality of second signal lines, wherein a first connector is provided at terminals of the plurality of power lines and the plurality of first signal lines, and a second connector is provided at terminals of the plurality of second signal lines.

8. The composite harness, according to claim 6, wherein one connector is provided at terminals of the plurality of power lines, the plurality of first signal lines, and the plurality of second signal lines, and a plurality of sensor signal lines are provided to extend from the one connector and are connected to the sensor, and the plurality of second signal lines and the plurality of sensor signal lines are electrically short-circuited.
